(19) United States
(12) Patent Application Publication
(10) Pub. No.: US 2013/0059166 A1
(43) Pub. Date: Mar. 7, 2013

(54) CUP-SHAPED MEMBER INCLUDING INNER PERIPHERAL CORRUGATED PORTION AND MANUFACTURING METHOD AND MANUFACTURING APPARATUS FOR THE SAME

(71) Applicants: Kotaro NAGATA, Anjo-shi (JP); Hiroki CHUJO, Nishio-shi (JP); Daisuke IWATA, Nishio-shi (JP)

(72) Inventors: Kotaro NAGATA, Anjo-shi (JP); Hiroki CHUJO, Nishio-shi (JP); Daisuke IWATA, Nishio-shi (JP)

(73) Assignee: AISIN AW CO., LTD., Anjo-shi (JP)

(21) Appl. No.: 13/599,464

(22) Filed: Aug. 30, 2012

(30) Foreign Application Priority Data
Sep. 1, 2011 (JP) 2011-190530

(51) Int. Cl. B32B 3/30; B21D 31/00

(52) U.S. Cl. 428/600; 72/379.2

(57) ABSTRACT

A cup-shaped member in which the outer peripheral recesses are formed on the base end portion side of the outer peripheral surface of the cylinder portion, on which the bottom portion is disposed, by denting the outer peripheral surface radially inward of the cylinder portion at positions that correspond to the inner peripheral protrusions. The smooth outer peripheral portion is formed on the opening end side of the outer peripheral surface of the cylinder portion that is opposite to the side on which the bottom portion is disposed. The smooth outer peripheral portion has no corrugation and has generally the same diameter over the entire circumference of the outer peripheral surface, thereby increasing the strength of the cup-shaped member, and allowing the inner peripheral corrugated portion to be surely formed.

### INCORPORATION BY REFERENCE

The disclosure of Japanese Patent Application No. 2011-190530 filed on Sep. 1, 2011 including the specification, drawings and abstract is incorporated herein by reference in its entirety.

### BACKGROUND OF THE INVENTION

The present invention relates to a cup-shaped member including an inner peripheral corrugated portion, and to a manufacturing method and a manufacturing apparatus for the same.

### DESCRIPTION OF THE RELATED ART

A cup-shaped member has been used for a clutch drum in an automatic transmission of a vehicle and the like. The cup-shaped member includes a disk-shaped bottom portion, a cylinder portion standing from the outer periphery of the bottom portion, and an inner peripheral corrugated portion provided on the inner peripheral surface of the cylinder portion. The cup-shaped member including the inner peripheral corrugated portion can be formed by pressing or flow forming. Compared with pressing, flow forming requires a facility having a more complicated structure, and produces a larger amount of residues after the process. Thus, the facility cost and the unit price of the member are likely to be high. Moreover, compared with pressing, flow forming requires a longer processing time, and thus has lower production efficiency.

Thus, when the cup-shaped member is formed by pressing, the facility cost and the unit price of the member can be reduced and production efficiency can be improved compared with the case where the cup-shaped member is formed by flow forming. Pressing is, therefore, preferably employed in terms of the manufacturing cost and production efficiency.

All of the conventional pressed articles available have a corrugated shape on the outer peripheral surface to form a corrugated shape on the inner peripheral surface.

For example, Japanese Patent Application Publication No. 2006-57687 (JP 2006-57687 A) describes a cup-shaped member 9 including an inner peripheral corrugated portion manufactured by pressing. As shown in FIG. 16 and FIG. 17, the cup-shaped member 9 as a conventional pressed article includes a bottom portion 92 and a cylinder portion 90 standing from the bottom portion 92. The cup-shaped member 9 has spline grooves 911 and spline protrusions 912 on the inner peripheral surface of the cylinder portion 90 and also has outer protrusions 913 and outer grooves 914 on the outer peripheral surface of the cylinder portion 90 at positions corresponding to the spline grooves 911 and the spline protrusions 912, respectively, on the inner peripheral surface. A groove bottom surface 915 of each of the outer grooves 914 is formed of a slope inclined outward with respect to the axis of the cylinder portion 90 toward an opening end portion 93 on the side opposite to an end portion on the bottom portion 92 side of the cylinder portion 90.

### SUMMARY OF THE INVENTION

The cup-shaped member 9 as a conventional pressed article has the following problems.

In the cup-shaped member 9, the outer grooves 914 are provided on the outer peripheral surface of the cylinder portion 90 over the entire length in the axial direction of the cylinder portion 90 at positions corresponding to the spline protrusions 912 on the inner peripheral surface. Thus, the thickness is reduced at the spline protrusions 912 by the depth of the outer groove portions 914. With the thickness at the spline protrusions 912 thus reduced, the cylinder portion 90 tends to have a lower strength.

The opening end portion 93 of the cylinder portion 90 is formed as an opened portion, and thus has lower rigidity than a bottom end portion 94 for which the bottom portion 92 serves as a reinforcement. Accordingly, the opening end portion 93 is more susceptible to an influence of the reduction of thickness at the spline protrusions 912, and thus a defect due to deformation and deflection is likely to occur in the opening end portion 93.

The present invention is made in view of the above-described circumstance and aims to provide a cup-shaped member including an inner peripheral corrugated portion whose strength is sufficiently secured and cost is low, and to provide a manufacturing method and a manufacturing apparatus for the same.

An aspect of the present invention provides a cup-shaped member including an inner peripheral corrugated portion, characterized in that the cup-shaped member is formed by pressing; the cup-shaped member includes a disk-shaped bottom portion, a cylinder portion standing upright with respect to an outer periphery of the bottom portion, and the inner peripheral corrugated portion having a plurality of inner peripheral protrusions that extend along an axial direction of the cylinder portion over an entire length in the axial direction of an inner peripheral surface of the cylinder portion and protrude radially inward of the cylinder portion, and inner peripheral recesses each being formed between adjacent ones of the inner peripheral protrusions; outer peripheral recesses are provided on a base end portion side of an outer peripheral surface of the cylinder portion, on which the bottom portion is disposed, and are formed by denting the outer peripheral surface radially inward of the cylinder portion at positions that correspond to the inner peripheral protrusions; and a smooth outer peripheral portion having generally the same diameter over an entire circumference of the outer peripheral surface is provided on an opening end portion side of the outer peripheral surface of the cylinder portion, which is a side opposite to the base end portion side on which the bottom portion is disposed.

Another aspect of the present invention provides a manufacturing method for a cup-shaped member including an inner corrugated portion, characterized by including: a drawing step of forming a disk-shaped material into a cup shape having a bottom portion and a cylinder portion standing upright with respect to the bottom portion; a first ironing step of forming, on an inner peripheral surface of the cylinder portion, the inner peripheral corrugated portion having a plurality of inner peripheral protrusions protruding radially inward of the cylinder portion and inner peripheral recesses each being formed between adjacent ones of the inner peripheral protrusions; and a second ironing step of forming, on a base end portion side of an outer peripheral surface of the cylinder portion, on which the bottom portion is disposed, outer peripheral recesses by denting the outer peripheral surface radially inward of the cylinder portion at positions that correspond to the inner peripheral protrusions, wherein a smooth outer peripheral portion having generally the same diameter over an entire circumference of the outer peripheral surface is provided on an opening end portion side of the outer peripheral surface of the cylinder portion, which is a side opposite to the base end portion side on which the bottom portion is disposed.

A still another aspect of the present invention provides a manufacturing apparatus for a cup-shaped member including an inner corrugated portion that includes a disk-shaped bottom portion, a cylinder portion standing upright with respect to the bottom portion, and in which the inner peripheral corrugated portion is formed on an inner surface of the cylinder portion, the manufacturing apparatus characterized by comprising: a punch having a generally column shape and including, on an outer peripheral surface, a punch tooth forming portion corresponding to the inner peripheral corrugated portion; and a plurality of dies that form the cup-shaped member in cooperation with the punch, wherein: the plurality of dies at least include a drawing die that has a circular drawing hole for forming a disk-shaped material into a cup shape, a first ironing die that has a circular first ironing hole for ironing an outer peripheral surface of the cylinder portion when forming, on the inner peripheral surface of the cylinder portion, the inner peripheral corrugated portion having a plurality of inner peripheral protrusions protruding radially inward of the cylinder portion and inner peripheral recesses each being formed between adjacent ones of the inner peripheral protrusions, and a second ironing die having a second ironing hole having die protrusions for forming, on a base end portion side of the outer peripheral surface of the cylinder portion, on which the bottom portion is disposed, outer peripheral recesses by denting the outer peripheral surface radially inward of the cylinder portion at positions that correspond to the inner peripheral protrusions; the punch tooth forming portion includes a plurality of punch tooth portions extending along an axial direction of the punch and protruding radially outward of the punch in the radial direction and punch groove portions each being provided between adjacent ones of the punch tooth portions; the die protrusions are provided at positions corresponding to the punch tooth portions of the punch tooth forming portion and protrude radially inward of the second ironing die; the drawing die, the first ironing die, and the second ironing die are sequentially arranged with center axes of the dies disposed on a straight line; and the punch is disposed to be capable of sequentially passing through the drawing hole, the first ironing hole, and the second ironing hole.

In the cup-shaped member, the outer peripheral recesses are formed on the base end portion side of the outer peripheral surface of the cylinder portion, on which the bottom portion is disposed, by denting the outer peripheral surface radially inward of the cylinder portion at positions that correspond to the inner peripheral protrusions. The smooth outer peripheral portion is formed on the opening end side of the outer peripheral surface of the cylinder portion that is opposite to the side on which the bottom portion is disposed. The smooth outer peripheral portion has no corrugation and has generally the same diameter over the entire circumference of the outer peripheral surface. Thus, the strength of the cup-shaped member can be enhanced, and the inner peripheral corrugated portion can be surely formed.

Specifically, in pressing, a deformation rate is large at a connection portion connecting between the bottom portion and the cylinder portion. Thus, insufficient filling of material might occur in the inner peripheral protrusions at a portion in the vicinity of the connection portion. To address this, the outer peripheral recesses are formed on the base end portion side, and thus a portion in the inner peripheral protrusions at which insufficient filling is likely to occur can be filled with a sufficient amount of material. Accordingly, the inner peripheral corrugated portion can be surely formed.

As described above, the inner peripheral corrugated portion can be formed accurately along the entire length in the axial direction with the outer peripheral recesses formed only on the base end portion side. Thus, on the opening end side of the outer peripheral surface, the outer peripheral recesses are not formed, but the smooth outer peripheral portion is formed on the opening end side. The smooth outer peripheral portion has generally the same diameter over the entire circumference of the outer peripheral surface, and thus is not dented from the outer periphery at the positions corresponding to the inner peripheral protrusions. Accordingly, the thickness is not reduced. Thus, the strength of a portion of the cylinder portion on the opening end side can be enhanced.

The manufacturing method for the cup-shaped member including the inner peripheral corrugated portion includes the drawing step, the first ironing step, and the second ironing step. Thus, an excellent cup-shaped member as described above can be readily obtained.

The manufacturing apparatus for the cup-shaped member including the inner peripheral corrugated portion includes the punch and at least three dies including the drawing die, the first ironing die, and the second ironing die. Thus, with the manufacturing apparatus for the cup-shaped member, an excellent manufacturing method as described above can be surely achieved, and the cup-shaped member can be readily manufactured.

The drawing die, the first ironing die, and the second ironing die are rectilinearly arranged and thus, the processing with the drawing die, the first ironing die, and the second ironing die can be performed in a single stroke of the punch. Accordingly, the productivity of the cup-shaped member can be enhanced.

### BRIEF DESCRIPTION OF THE DRAWINGS

FIG. 1 is an explanatory view of a cup-shaped member including an inner peripheral corrugated portion in a first embodiment;

FIG. 2 is a partial sectional view taken along lines indicated by arrows A-A in FIG. 1;

FIG. 3 is a partial sectional view taken along lines indicated by arrows B-B in FIG. 2;

FIG. 4 is a partial sectional view taken along lines indicated by arrows C-C in FIG. 2;

FIG. 5 is an explanatory view of a manufacturing apparatus for a cup-shaped member before being formed in the first embodiment;

FIG. 6 is an explanatory view of the manufacturing apparatus for a cup-shaped member in a state where a material is sandwiched in the first embodiment;

FIG. 7 is an explanatory view of the manufacturing apparatus for a cup-shaped member after a drawing step in the first embodiment;

FIG. 8 is an explanatory view of the manufacturing apparatus for a cup-shaped member after a first ironing step in the first embodiment;

FIG. 9 is an explanatory view of the manufacturing apparatus for a cup-shaped member after a second ironing step in the first embodiment;

FIG. 10 is an enlarged sectional view of an upper punch and a lower punch in the first embodiment;

FIG. 11 is an explanatory view illustrating the shape of the upper punch as viewed in a direction indicated by an arrow E in FIG. 10;

FIG. 12 is a cross-sectional view taken along lines indicated by arrows F-F in FIG. 5;

FIG. 13 is a sectional view taken along lines indicated by arrows G-G in

FIG. 12;

FIG. 14A is a partial sectional view of the material before being formed,

FIG. 14B is a partial sectional view of the material sandwiched by the upper punch and the lower punch, and FIG. 14C is a partial sectional view of the cup-shaped member after the drawing step, in the first embodiment;

FIG. 15A is an explanatory view of the cup-shaped member after the first ironing step, and FIG. 15B is an explanatory view of the cup-shaped member after the second ironing step, in the first embodiment;

FIG. 16 is an explanatory view of a cup-shaped member in related art; and

FIG. 17 is a sectional view taken along lines indicated by arrows H-H in

FIG. 16.

### DETAILED DESCRIPTION OF THE EMBODIMENTS

The cup-shaped member may be a clutch drum in an automatic transmission having a snap ring groove formed on the opening end side of the inner peripheral surface of the cylinder portion. The clutch drum has a cup shape, and the inner peripheral corrugated portion is formed on the inner peripheral surface of the cylinder portion, while the snap ring groove is formed on the opening end side on the inner peripheral surface. A portion of the cylinder portion at which the snap ring groove is formed is thinner than the other portions of the cylinder portion and thus, the strength is likely to be reduced.

Thus, to prevent the reduction in strength due to the snap ring groove and secure sufficient strength, it is effective to make the portion corresponding to the snap ring groove thick. With the cup-shaped member including the inner corrugated portion used as a clutch drum, the thickness is not reduced at the inner peripheral protrusions and the thickness in the vicinity of the snap ring groove can be secured. By thus securing the thickness, strength for holding components such as a clutch plate and rotational rigidity for suppressing an amount of deformation due to rotation can be enhanced. Thus, a low-cost clutch drum satisfying required performances can be obtained.

In the manufacturing apparatus for the cup-shaped member, the inner peripheral surface of the second ironing die may be provided with a reduced diameter portion, an entrance tapered portion having a diameter gradually reducing from one opening edge of the second ironing hole through which the punch enters toward the reduced diameter portion, and an exit tapered portion having a diameter gradually reducing from the other opening edge on the side opposite to the one opening edge toward the reduced diameter portion. In this case, a contact area can be small between the die protrusions on the second ironing hole and the outer peripheral surface of the cup-shaped member during forming of the outer peripheral recesses of the cup-shaped member. Thus, force applied from the die protrusions to the outer peripheral surface of the cup-shaped member can be concentrated. Accordingly, the outer peripheral recesses can be accurately formed on the cup-shaped member, while reducing ironing resistance.

### Embodiment

### First Embodiment

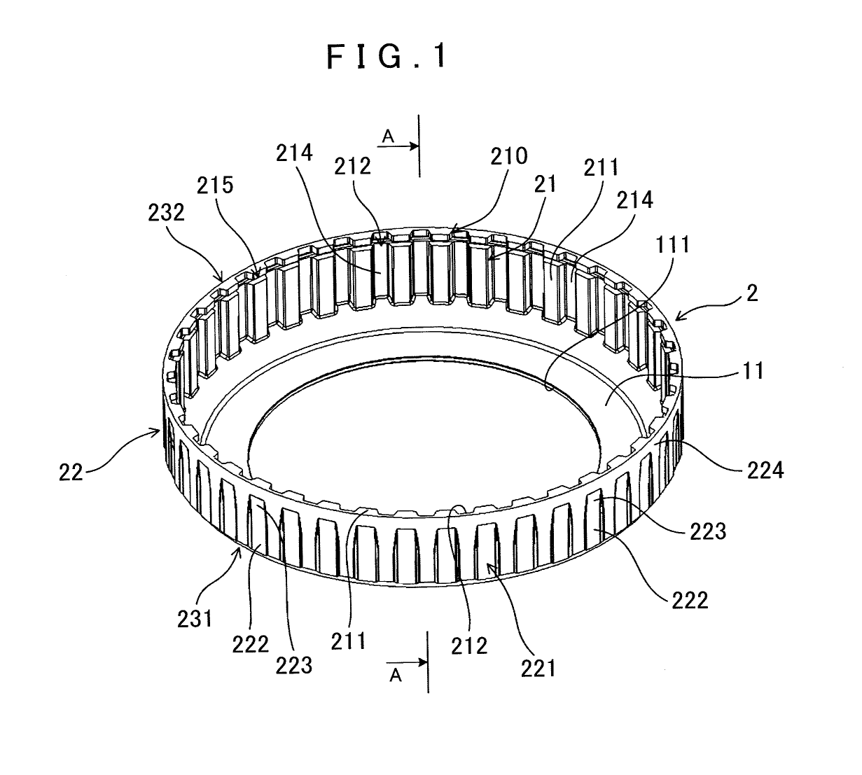

An embodiment of a cup-shaped member including an inner peripheral corrugated portion, and a manufacturing method and a manufacturing apparatus for the same will be described with reference to FIG. 1 to FIG. 15.

As shown in FIG. 1, a cup-shaped member 1 including an inner peripheral corrugated portion 210 is formed by pressing and includes a disk-shaped bottom portion 11 and a cylinder portion 2 standing upright with respect to the outer periphery of the bottom portion 11. The cup-shaped member 1 including the inner peripheral corrugated portion 210 includes the inner peripheral corrugated portion 210 having a plurality of inner peripheral protrusions 211 and inner peripheral recesses 212. The inner peripheral protrusions 211 extend along the axial direction of the cylinder portion 2 over the entire length in the axial direction of an inner peripheral surface 21 of the cylinder portion 2 and protrude radially inward of the cylinder portion 2. The inner peripheral recesses 212 are each formed between adjacent ones of the inner peripheral protrusions 211.

On a base end portion 231 side of the outer peripheral surface 22 of the cylinder portion 2, on which the bottom portion 11 is disposed, outer peripheral recesses 221 are formed at the positions corresponding to the inner peripheral protrusions 211. The outer peripheral recesses 221 are formed by denting the outer peripheral surface 22 of the cylinder portion 2 radially inward. A smooth outer peripheral portion 224 having generally the same diameter over the entire circumference of the outer peripheral surface 22 is formed on an opening end portion 232 side opposite to the side on which the bottom portion 11 is disposed in the cylinder portion 2.

The cup-shaped member 1 including the inner peripheral corrugated portion 210 of this embodiment will be described more in detail.

In this embodiment, a direction along the axis of the cup-shaped member 1 is defined as the axial direction, while a direction perpendicular to the axial direction is defined as the radial direction.

A distal end side of an upper punch 31 of a manufacturing apparatus 3 to be described later is defined as the lower side, while a side opposite thereto is defined as the upper side.

The cup-shaped member 1 of this embodiment is a clutch drum in an automatic transmission for use in a vehicle.

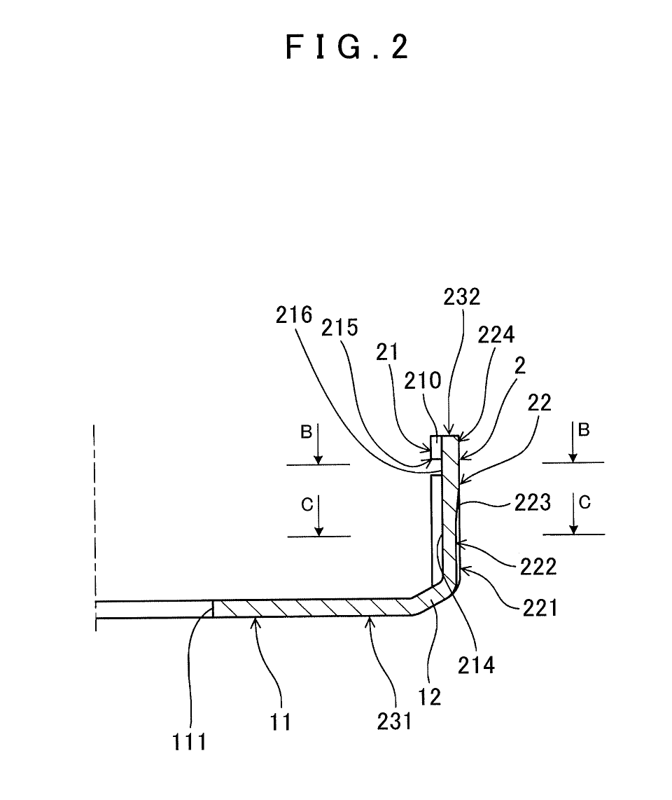

As shown in FIG. 1 and FIG. 2, the cup-shaped member 1 includes the disk-shaped bottom portion 11 and the cylinder portion 2 standing upright with respect to the outer periphery of the bottom portion 11.

The bottom portion 11 has an annular shape with a through hole 111 formed at the center thereof.

The cylinder portion 2 has a larger diameter than the bottom portion 11. The bottom portion 11 and the cylinder portion 2 are connected by a cup tapered portion 12 whose diameter reduces from the diameter of the cylinder portion 2 to the diameter of the bottom portion 11.

The inner peripheral surface 21 and the outer peripheral surface 22 are provided with the inner peripheral corrugated portion 210 and the outer peripheral recesses 221, respectively.

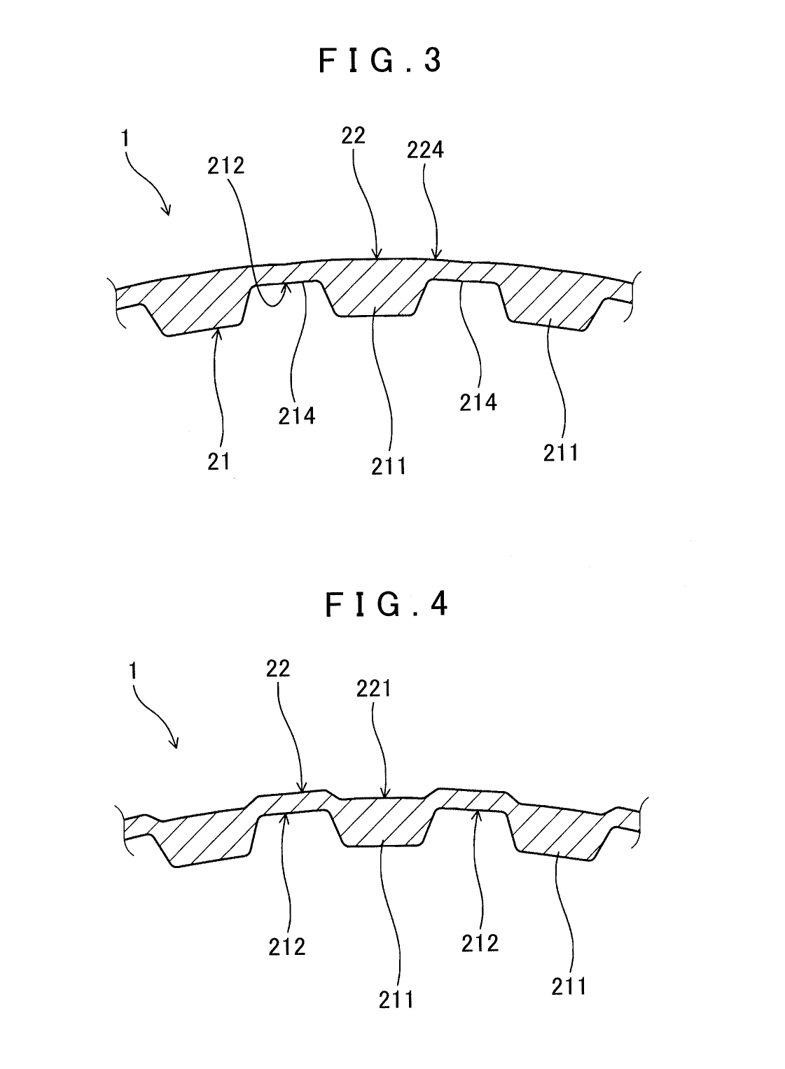

As shown in FIG. 1 and FIG. 3, the inner peripheral corrugated portion 210 extends over the entire length in the axial direction of the inner peripheral surface 21. The inner peripheral corrugated portion 210 includes the plurality of inner peripheral protrusions 211 extending along the axial direction and protruding radially inward of the cylinder portion 2 and the inner peripheral recesses 212 each formed between adjacent ones of the inner peripheral protrusions 211. The inner peripheral protrusions 211 each have a generally trapezoidal cross-sectional shape on a plane perpendicular to the axial direction. Adjacent ones of the inner peripheral protrusions 211 are formed at predetermined intervals where the inner peripheral recesses 212 each having a recess bottom surface 214 are formed.

As shown in FIG. 1 to FIG. 4, the outer peripheral surface 22 of the cylinder portion 2 is provided with the outer peripheral recesses 221 and the smooth outer peripheral portion 224.

The outer peripheral recesses 221 are formed at positions corresponding to the inner peripheral protrusions 211 on the outer peripheral surface 22 and on the base end portion 231 side of the outer peripheral surface 22, on which the bottom portion 11 is disposed. The outer peripheral recesses 221 each include a planer portion 222 formed on a plane perpendicular to the normal to the outer peripheral surface 22 and a slope 223 inclined with respect to the flat portion 222. The planer portion 222 is formed on the base end portion 231 side of the outer peripheral recesses 221. The slope 223 is formed on the opening end 232 side of the outer peripheral recesses 221, and is inclined outward with respect to the center axis of the cylinder portion 2 from the planer portion 222 toward the opening end portion 232.

The smooth outer peripheral portion 224 is provided on the opening end portion 232 side of the outer peripheral surface 22 of the cylinder portion 2. The smooth outer peripheral portion 224 has generally the same diameter over the entire circumference of the outer peripheral surface 22, and the outer shape of the smooth outer peripheral portion 224 on the plane perpendicular to the axial direction is generally a true circle.

As shown in FIG. 1, a clutch drum as the cup-shaped member 1 includes a snap ring groove 215 formed at a position closer to the opening end 232 on the inner peripheral surface 21 of the cylinder portion 2 and circumferentially formed at a position corresponding to the smooth outer peripheral portion 224. As shown in FIG. 2, the snap ring groove 215 is formed by cutting the inner peripheral protrusions 211 in such a manner that the positions of grove bottom surfaces 216 of the snap ring groove 215 in the radial direction are generally the same as the positions of the recess bottom surfaces 214.

Next, the manufacturing apparatus 3 for the cup-shaped member 1 for manufacturing the cup-shaped member 1 is described.

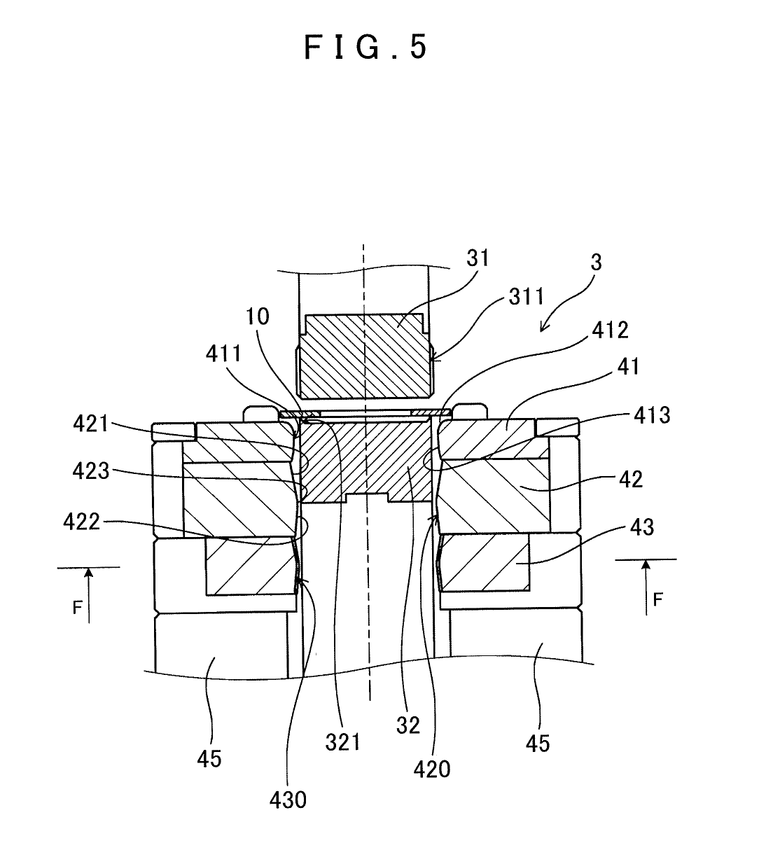

As shown in FIG. 5, the manufacturing apparatus 3 for the cup-shaped member 1 includes: an upper punch 31 having a generally column shape; three dies including a drawing die 41, a first ironing die 42, and a second ironing die 43 that form the cup-shaped member 1 in corporation with the upper punch 31; and a one-stroke press machine (not shown) that causes the upper punch 31 to reciprocate in the axial direction.

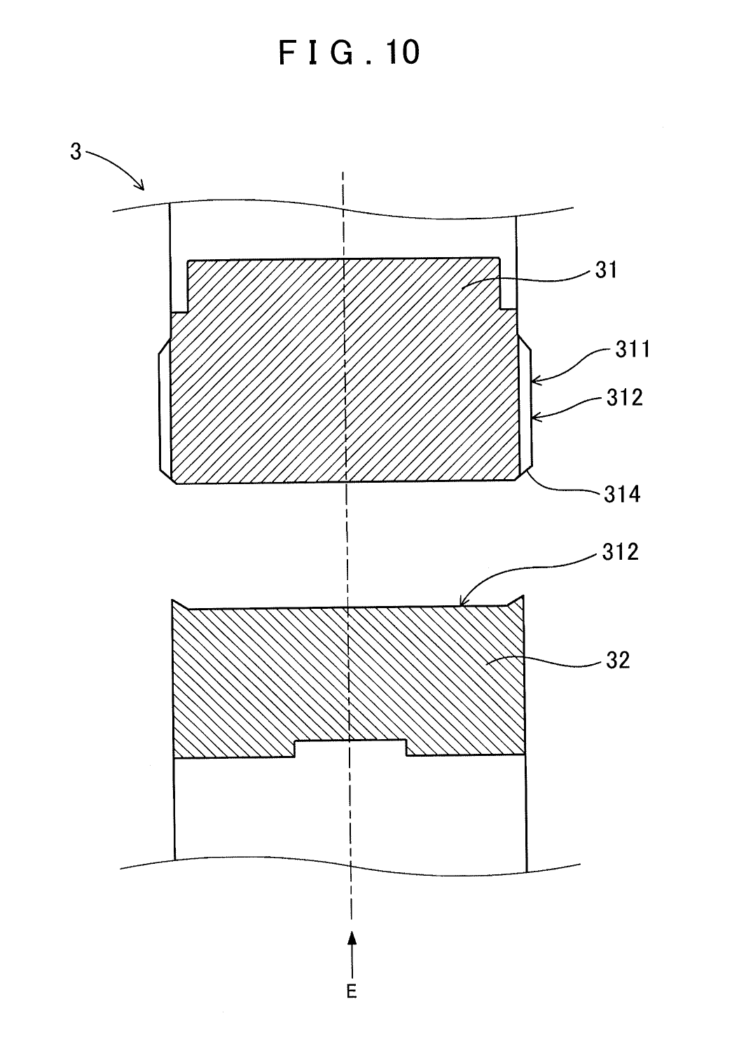

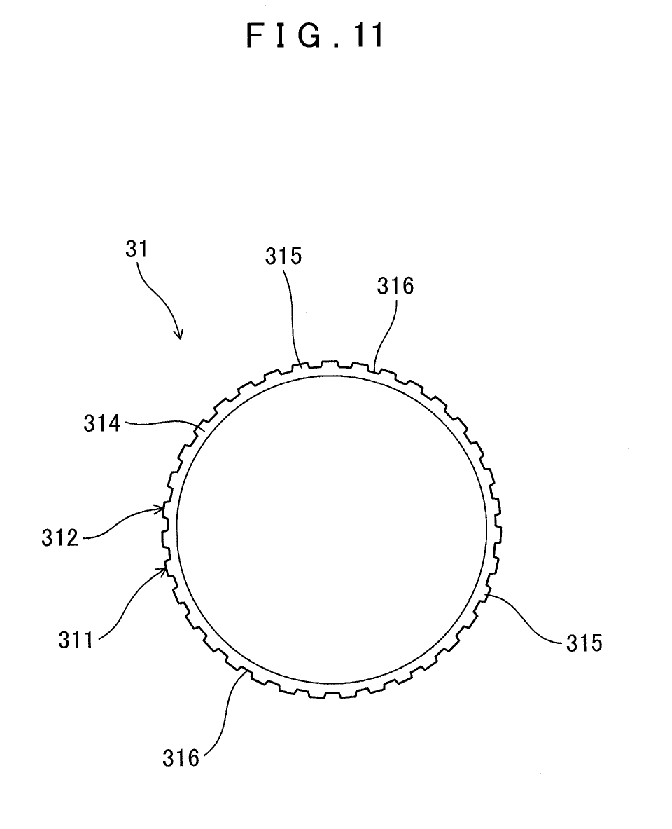

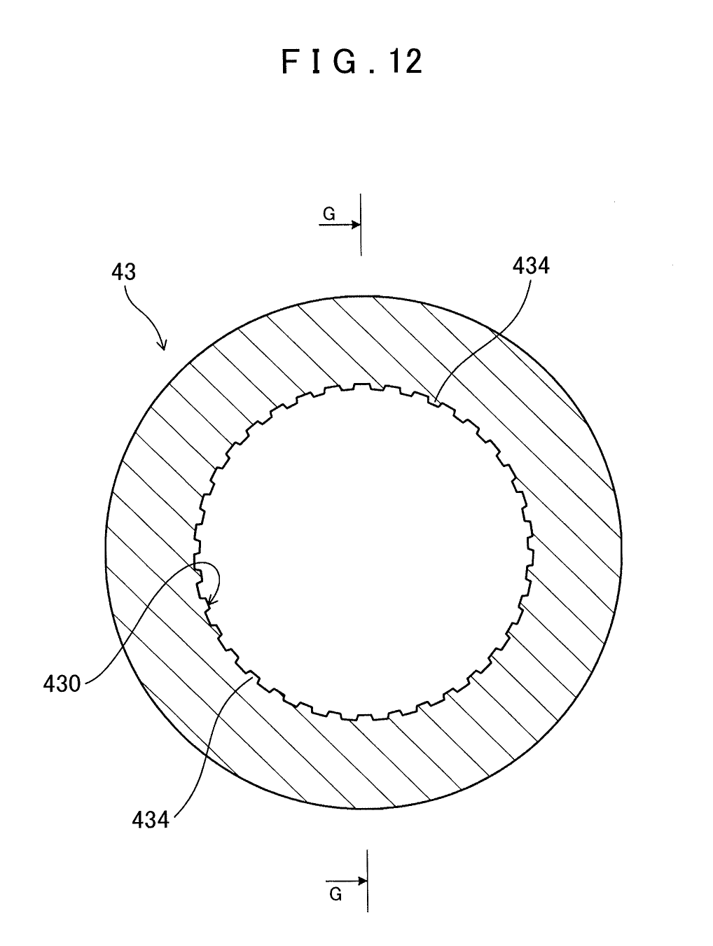

As shown in FIG. 5, FIG. 10, and FIG. 11, the upper punch 31 has a generally column shape extending along the axial direction. The upper punch 31 includes, on a punch outer peripheral surface 311, a punch tooth forming portion 312 including punch tooth portions 315 having a shape corresponding to the inner peripheral recesses 212 of the inner peripheral corrugated portion 210 of the cup-shaped member 1 and punch groove portions 316 having a shape corresponding to the inner peripheral protrusions 211. A punch distal end portion 313 at a lower end of the upper punch 31 includes, on an outer peripheral edge portion, a punch tapered portion 314 whose diameter reduces toward the distal end of the upper punch 31.

A base end portion of the upper punch 31 is coupled to an upper driving source (not shown) of the one-stroke pressing machine, and thus is structured to be capable of reciprocating in the axial direction.

As shown in FIG. 5 and FIG. 10, a lower punch 32 is disposed below the upper punch 31. The lower punch 32 has a generally column shape extending in the axial direction, and includes a lower punch recess 321 having a shape corresponding to the punch distal end portion 313 on an upper surface thereof.

The lower punch 32 has a lower end portion coupled to a lower driving source (not shown) of the one-stroke pressing machine, and thus is structured to be capable of reciprocating in the up-down direction.

As shown in FIG. 5, the drawing die 41 has a generally annular shape, and the inner peripheral surface thereof forms a circular drawing hole 411 for forming a disk-shaped material 10 into a cup shape. The drawing hole 411 is provided with a fillet 412 at an upper edge portion on the upper side, and includes a punch release portion 413 having a tapered shape whose diameter increases downward from the lower end of the fillet 412.

The first ironing die 42 is disposed below the drawing die 41.

As shown in FIG. 5, the first ironing die 42 has a generally annular shape, and the inner peripheral surface thereof forms a circular, first ironing hole 420 for ironing the outer peripheral surface 22 of the cylinder portion 2 to form the inner peripheral corrugated portion 210. The first ironing hole 420 includes a first entrance tapered portion 421 and a first exit tapered portion 422.

The first entrance tapered portion 421 has a diameter reducing from an opening edge on the upper side toward a first reduced diameter portion 423 at a generally center position in the axial direction of the first ironing die 42.

The first exit tapered portion 422 has a diameter increasing from the first reduced diameter portion 423 of the first ironing die 42 toward an opening edge on the lower side The first ironing hole 420 has a circular cross-sectional shape on a plane perpendicular to the axial direction at any position.

The first ironing die 42 is structured to be rotatable at a predetermined angle about the center axis thereof every time forming is performed for a predetermined number of times. Thus, uneven wearing of the first ironing die 42 can be prevented and thus can have a longer service life.

Specifically, using the upper punch 31 and the first ironing die 42, hard ironing with a high ironing rate is performed between the punch tooth portions 315 of the punch tooth forming portion 312 and the first ironing hole 420. The hard ironing is accompanied by high surface pressure, and therefore, the portions of the first ironing hole 420 facing the punch tooth portions 315 are likely to wear, and thus uneven wearing occurs on the inner peripheral surface of the first ironing die 42.

To address this, the first ironing die 42 of this embodiment is structured to be rotatable at a predetermined angle every time forming is performed for a predetermined number of times as described above. Thus, the portions of the first ironing hole 420 facing the punch tooth portions 315 can be moved to face the punch groove portions 316. Accordingly, uneven wearing of the inner peripheral surface of the first ironing die 42 can be prevented and the first ironing die 42 can have a longer service life.

The number of forming times required to rotate the first ironing die 42 and the rotation angle of the first ironing die 42 can be set as desired.

The second ironing die 43 is disposed below the first ironing die 42.

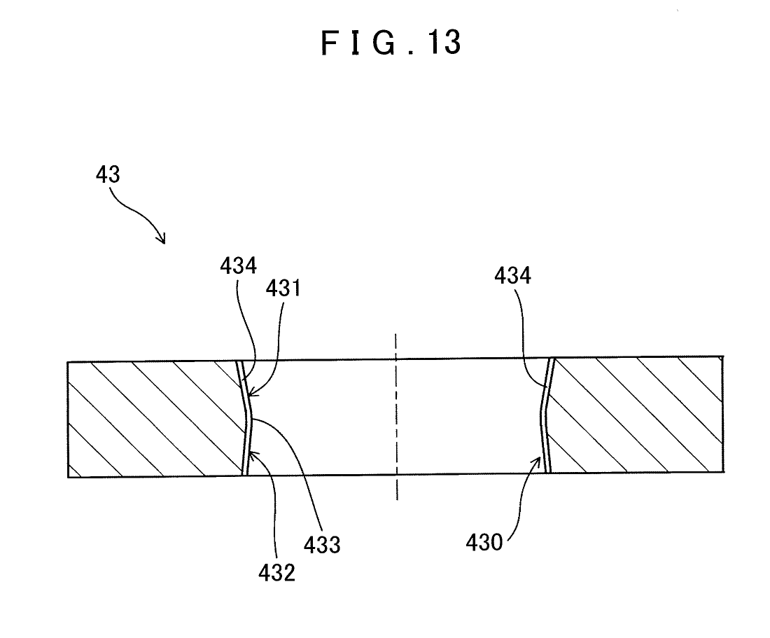

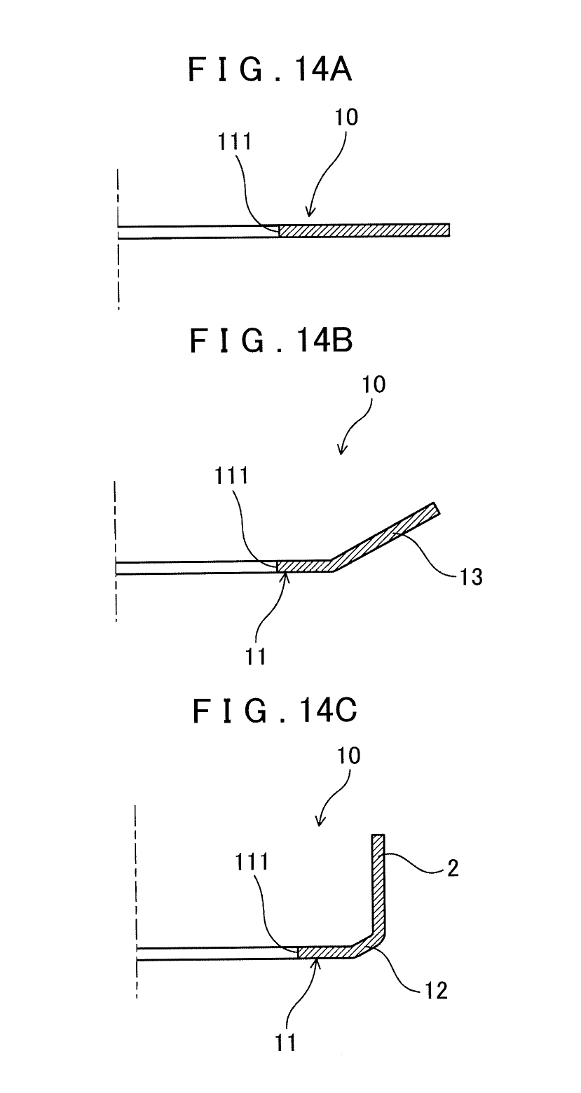

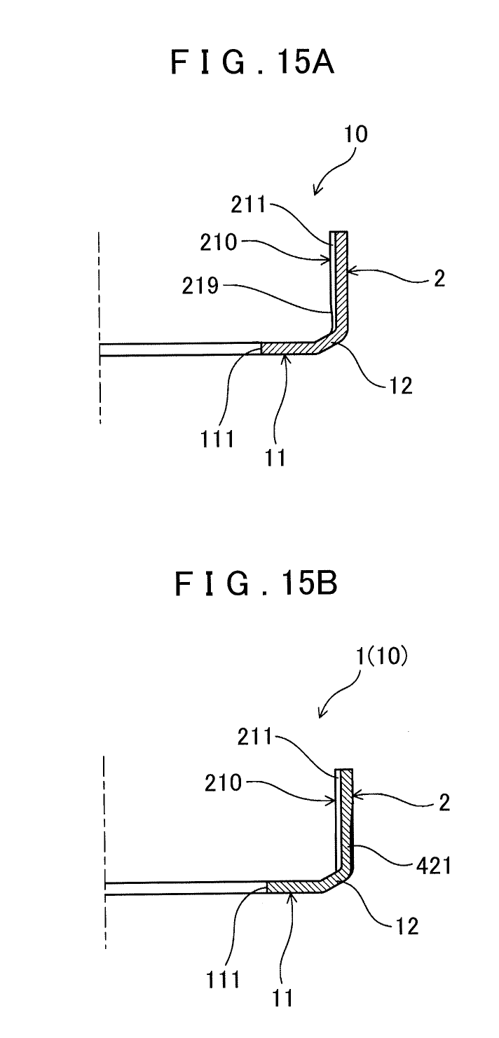

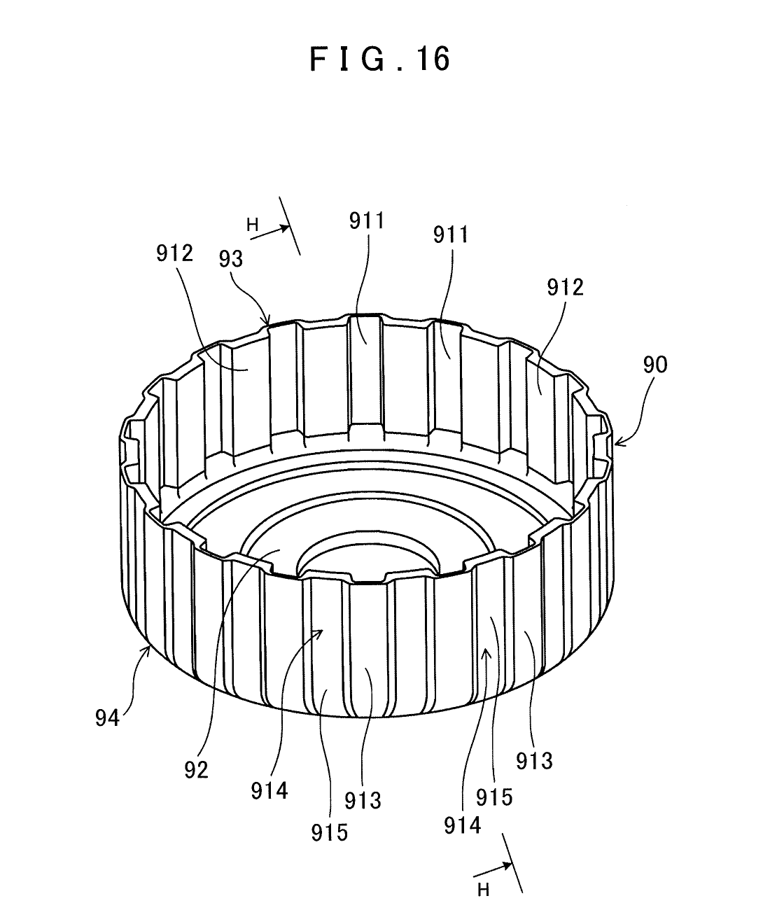

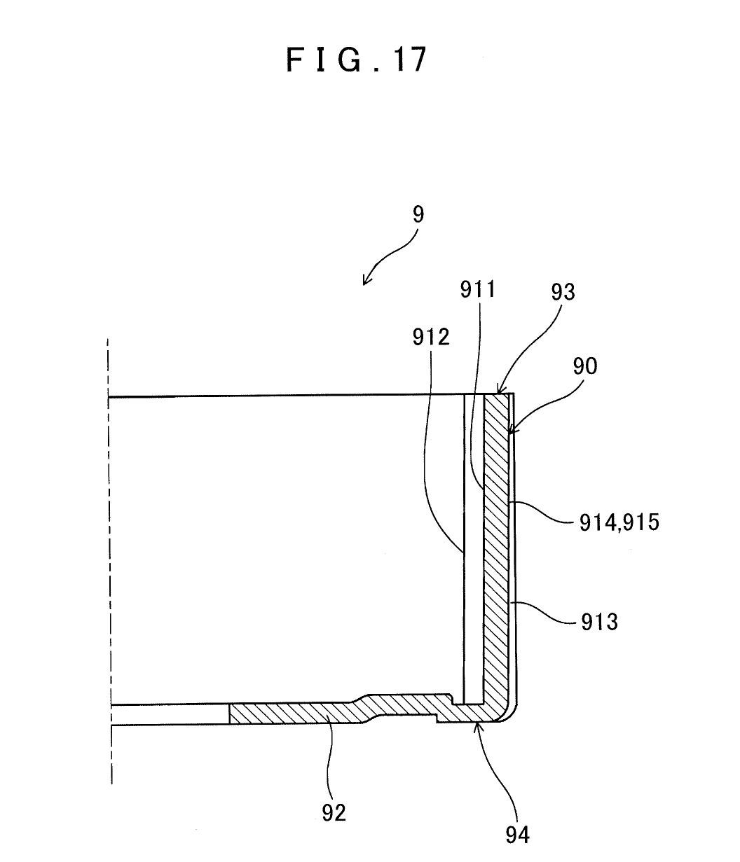

As shown in FIG. 5, FIG. 12, and FIG. 13, the second ironing die 43 has a generally annular shape, and the inner peripheral surface thereof forms a second ironing hole 430 provided with die protrusions 434 for forming the outer peripheral recesses 221.

As shown in FIG. 13, the second ironing hole 430 includes a second entrance tapered portion 431 and a second exit tapered portion 432. The second entrance tapered portion 431 has a diameter reducing from an upper opening edge on the upper side toward a second reduced diameter portion 433 at a generally center position in the axial direction of the second ironing die 43. The second exit tapered portion 432 has a diameter reducing from a lower opening edge on the lower side toward the second reduced diameter portion 433 of the second ironing die 43.

The die protrusions 434 are formed so as to extend along the axial direction on the surface forming the second entrance tapered portion 431 and the second exit tapered portion 432.

As shown in FIG. 5, the drawing die 41, the first ironing die 42, and the second ironing die 43 are stacked on a press base portion 45 disposed on a floor surface, in this order from the top. The drawing die 41, the first ironing die 42, and the second ironing die 43 are disposed in such a manner that the center lines of the dies are disposed on a single straight line.

The cup-shaped member 1 is manufactured with the thus structured manufacturing apparatus 3 for the cup-shaped member 1.

First, the material 10 formed into an annular shape as shown in FIG. 14A by pressing is placed on the lower punch 32 as shown in FIG. 5.

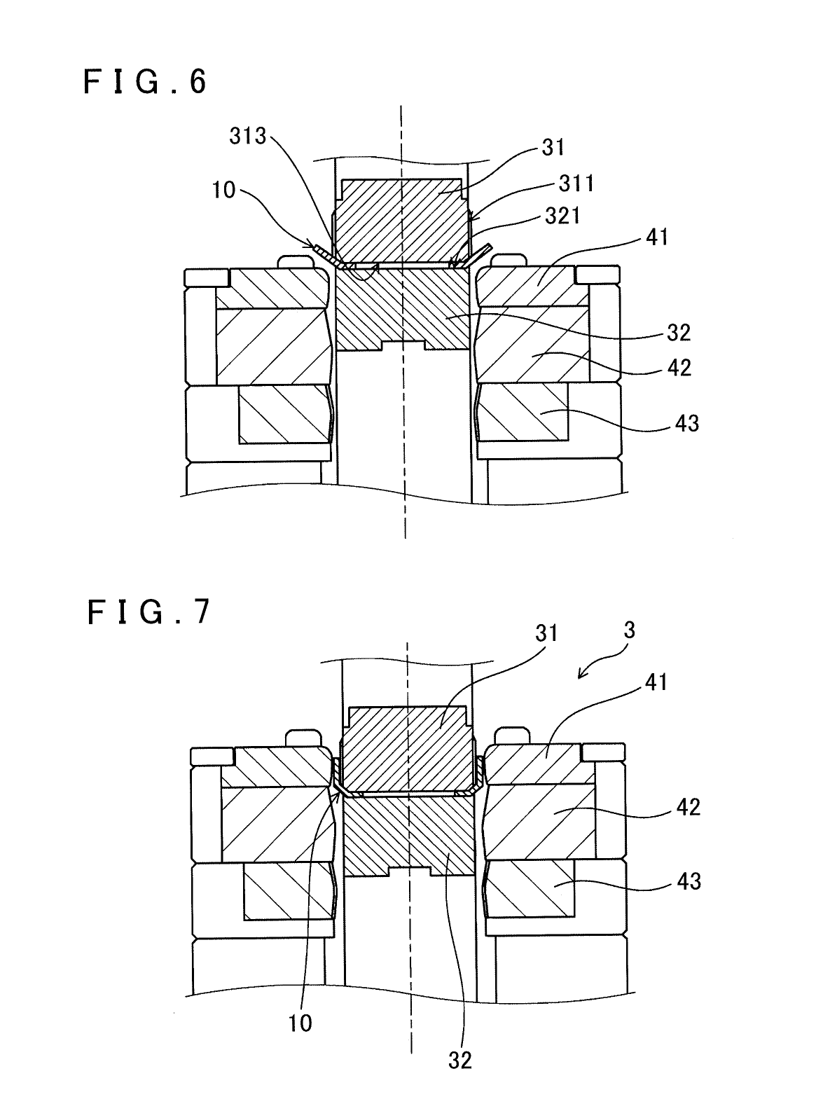

Then, as shown in FIG. 6, the upper punch 31 is moved downward by the upper driving source. Here, the material 10 deforms along the punch distal end portion 313 and the lower punch recess 321 on the upper surface of the lower punch 32, so that the bottom portion 11 and a slope 13 inclined upward from the bottom portion 11 are formed as shown in FIG. 14B.

Then, the manufacturing proceeds to a drawing step.

As shown in FIG. 7, the drawing step is performed as the material 10 moves downward while being sandwiched by the upper punch 31 and the lower punch 32 to pass through the drawing hole 411 of the drawing die 41. Thus, as shown in FIG. 14C, the cylinder portion 2 standing upward is formed in a portion on the outer peripheral side of an outer peripheral side portion of the slope 13 of the material 10.

Then, the manufacturing proceeds to a first ironing step.

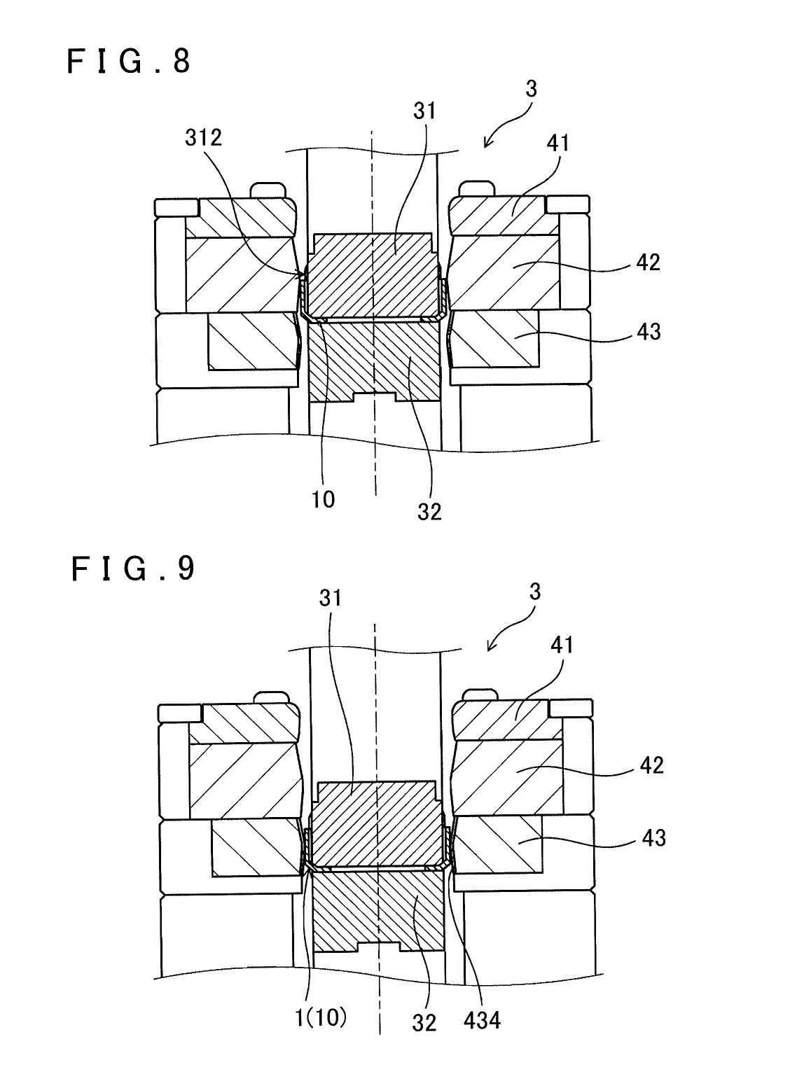

As shown in FIG. 8, the ironing step is performed as the material 10 moves downward while being sandwiched by the upper punch 31 and the lower punch 32 to pass through the first ironing hole 420 of the first ironing die 42. On the inner peripheral surface 21 of the cylinder portion 2 ironed by the upper punch 31 and the first ironing die 42, the material moves along the punch tooth forming portions 312 of the upper punch 31. Thus, the inner corrugated portion 210 is formed on the inner peripheral surface 21 of the cylinder portion 2 as shown in FIG. 15A. At this time, a material insufficiently filled portion 219 might be formed in the inner peripheral protrusions 211 at a connection portion connecting between the cup-tapered portion 12 and the cylinder portion 2. At the point where the first ironing step is completed, the outer peripheral surface 22 of the cylinder portion 2 is a smooth curved surface.

Then, the manufacturing proceeds to a second ironing step.

As shown in FIG. 9, the ironing step is performed as the material 10 moves downward while being sandwiched by the upper punch 31 and the lower punch 32 to be inserted in the second ironing die 43 as shown in FIG. 9. The downward movement of the upper punch 31 and the lower punch 32 is stopped when the second reduced diameter portion 433 (FIG. 13) of the second ironing die 43 reaches the vicinity of the center in the axial direction of the cylinder portion 2 of the cup-shaped member 1. Thus, the connection portion in the inner peripheral protrusions 211 that connects between the cup-tapered portion 12 and the cylinder portion 2 is filled with a sufficient amount of material. Moreover, a smooth curved surface remains on the opening end portion 232 side of the outer peripheral surface 22 of the cylinder portion 2. Accordingly, the smooth outer peripheral portion 224 having generally the same diameter over the entire circumference of the outer peripheral surface 22 is provided. The manufacturing of the cup-shaped member 1 including the inner peripheral corrugated portion 210 is thus completed.

Next, operations and effects of this embodiment are described.

In the cup-shaped member 1, the outer peripheral recesses 221 are formed on the base end portion 231 side of the outer peripheral surface 22 of the cylinder portion 2, on which the bottom portion 11 is disposed. The outer peripheral recesses 221 are formed by denting the outer peripheral surface 22 radially inward of the cylinder portion 2 at positions corresponding to the inner peripheral protrusions 211. The smooth outer peripheral portion 224 is formed on the opening end 232 side of the outer peripheral surface 22 of the cylinder portion 2, which is opposite to the side on which the bottom portion 11 is disposed. The smooth outer peripheral portion 224 is not corrugated and has generally the same diameter over the entire circumference of the outer peripheral surface 22. Thus, the strength of the cup-shaped member 1 can be enhanced, and the inner peripheral corrugated portion 210 can be surely formed.

Specifically, in pressing, a deformation rate is large at the connection portion connecting between the bottom portion 11 and the cylinder portion 2, which may results in insufficient filling of material in the inner peripheral protrusions 211 at the portion in the vicinity of the connection portion. To address this, the outer peripheral recesses 221 are formed on the base end portion 231 side, and thus the portion in the inner peripheral protrusions 211 at which insufficient filling is likely to occur can be filled with a sufficient amount of material. Accordingly, the inner peripheral corrugated portion 210 can be surely formed.

As described above, the inner peripheral corrugated portion 210 can be formed accurately along the entire length in the axial direction with the outer peripheral recesses 221 formed only on the base end portion 231 side. Thus, on the opening end 232 side of the outer peripheral surface 22, the outer peripheral recesses 221 are not formed, but the smooth outer peripheral portion 224 is formed on the opening end 232 side. The smooth outer peripheral portion 224 has generally the same diameter over the entire circumference of the outer peripheral surface 22, and thus is not dented from the outer periphery at the positions corresponding to the inner peripheral protrusions 211 and the thickness is not reduced. Thus, the strength of the portion of the cylinder portion 2 on the opening end 232 side can be enhanced.

The cup-shaped member 1 is a clutch drum in an automatic transmission having the snap ring groove 215 on the opening end 232 side of the inner peripheral surface 21 of the cylinder portion 2. The clutch drum has a cup shape, and the inner peripheral corrugated portion 210 is provided on the inner peripheral surface 21 of the cylinder portion 2 of the clutch drum, while the snap ring groove 215 is formed on the opening end 232 side of the inner peripheral surface 21. The portion at which the snap ring groove 215 is formed is thinner than the other portions and thus, the strength is likely to be reduced.

To prevent the reduction in strength due to the snap ring groove 215 and secure sufficient strength, it is effective to make the portion corresponding to the snap ring groove 215 thick. With the cup-shaped member 1 including the inner corrugated portion 210 used as a clutch drum, the thickness is not reduced at the inner peripheral protrusions 211 and the thickness in the vicinity of the snap ring groove 215 can be secured. By thus securing the thickness, strength for holding components such as a clutch plate and rotational rigidity for suppressing an amount of deformation due to rotation can be enhanced. Thus, a low-cost clutch drum satisfying required performances can be obtained.

The manufacturing method for the cup-shaped member 1 including the inner peripheral corrugated portion 210 includes the drawing step, the first ironing step, and the second ironing step. Thus, an excellent cup-shaped member 1 as described above can be readily obtained.

The manufacturing apparatus for the cup-shaped member 1 including the inner peripheral corrugated portion 210 includes the upper punch 31 and at least three dies, namely, the drawing die 41, the first ironing die 42, and the second ironing die 43.

Thus, with the manufacturing apparatus for the cup-shaped member 1, an excellent manufacturing method as described above can be surely achieved, and the cup-shaped member 1 can be readily manufactured.

The drawing die 41, the first ironing die 42, and the second ironing die 43 are rectilinearly arranged. Accordingly, the processing with the drawing die 41, the first ironing die 42, and the second ironing die 43 can be performed in a single stroke of the upper punch 31, and the productivity of the cup-shaped member 1 can be enhanced.

The inner peripheral surface of the second ironing die 43 is provided with the second reduced diameter portion 433, the second entrance tapered portion 431 having a diameter reducing from the upper opening edge on the upper side of the second ironing hole 430 toward the second reduced diameter portion 433, and the exit tapered portion 432 having a diameter reducing from the lower opening edge on the lower side to the second reduced diameter portion 433. Accordingly, a contact area can be small between the second ironing hole 430 and the outer peripheral surface 22 of the cup-shaped member 1 during forming of the outer peripheral recesses 221 of the cup-shaped member 1. Thus, force applied from the die protrusions 434 to the outer peripheral surface 22 of the cup-shaped member 1 can be concentrated. Accordingly, the outer peripheral recesses 221 can be accurately formed on the cup-shaped member 1, while reducing ironing resistance.

What is claimed is:

1. A cup-shaped member including an inner peripheral corrugated portion, wherein:
the cup-shaped member is formed by pressing;
the cup-shaped member includes
a disk-shaped bottom portion,
a cylinder portion standing upright with respect to an outer periphery of the bottom portion, and
the inner peripheral corrugated portion having a plurality of inner peripheral protrusions that extend along an axial direction of the cylinder portion over an entire length in the axial direction of an inner peripheral surface of the cylinder portion and protrude radially inward of the cylinder portion, and inner peripheral recesses each being formed between adjacent ones of the inner peripheral protrusions;
outer peripheral recesses are provided on a base end portion side of an outer peripheral surface of the cylinder portion, on which the bottom portion is disposed, and are formed by denting the outer peripheral surface radially inward of the cylinder portion at positions that correspond to the inner peripheral protrusions; and
a smooth outer peripheral portion having generally the same diameter over an entire circumference of the outer peripheral surface is provided on an opening end portion side of the outer peripheral surface of the cylinder portion, which is a side opposite to the base end portion side on which the bottom portion is disposed.

2. The cup-shaped member including an inner peripheral corrugated portion according to claim 1, wherein
the cup-shaped member is a clutch drum in an automatic transmission having a snap ring groove formed on the opening end side of the inner peripheral surface of the cylinder portion.

3. A manufacturing method for a cup-shaped member including an inner corrugated portion, comprising:
a drawing step of forming a disk-shaped material into a cup shape having a bottom portion and a cylinder portion standing upright with respect to the bottom portion;
a first ironing step of forming, on an inner peripheral surface of the cylinder portion, the inner peripheral corrugated portion having a plurality of inner peripheral protrusions protruding radially inward of the cylinder portion and inner peripheral recesses each being formed between adjacent ones of the inner peripheral protrusions; and
a second ironing step of forming, on a base end portion side of an outer peripheral surface of the cylinder portion, on which the bottom portion is disposed, outer peripheral recesses by denting the outer peripheral surface radially inward of the cylinder portion at positions that correspond to the inner peripheral protrusions, wherein
a smooth outer peripheral portion having generally the same diameter over an entire circumference of the outer peripheral surface is provided on an opening end portion side of the outer peripheral surface of the cylinder portion, which is a side opposite to the base end portion side on which the bottom portion is disposed.

4. A manufacturing apparatus for a cup-shaped member including an inner corrugated portion that includes a disk-shaped bottom portion, a cylinder portion standing upright with respect to the bottom portion, and in which the inner peripheral corrugated portion is formed on an inner surface of the cylinder portion, the manufacturing apparatus comprising:
a punch having a generally column shape and including, on an outer peripheral surface, a punch tooth forming portion corresponding to the inner peripheral corrugated portion; and
a plurality of dies that form the cup-shaped member in cooperation with the punch, wherein:
the plurality of dies at least include
a drawing die that has a circular drawing hole for forming a disk-shaped material into a cup shape,
a first ironing die that has a circular first ironing hole for ironing an outer peripheral surface of the cylinder portion when forming, on the inner peripheral surface of the cylinder portion, the inner peripheral corrugated portion having a plurality of inner peripheral protrusions protruding radially inward of the cylinder portion and inner peripheral recesses each being formed between adjacent ones of the inner peripheral protrusions, and
a second ironing die having a second ironing hole having die protrusions for forming, on a base end portion side of the outer peripheral surface of the cylinder portion, on which the bottom portion is disposed, outer peripheral recesses by denting the outer peripheral surface radially inward of the cylinder portion at positions that correspond to the inner peripheral protrusions;
the punch tooth forming portion includes a plurality of punch tooth portions extending along an axial direction of the punch and protruding radially outward of the punch in the radial direction and punch groove portions each being provided between adjacent ones of the punch tooth portions;
the die protrusions are provided at positions corresponding to the punch tooth portions of the punch tooth forming portion and protrude radially inward of the second ironing die;
the drawing die, the first ironing die, and the second ironing die are sequentially arranged with center axes of the dies disposed on a straight line; and
the punch is disposed to be capable of sequentially passing through the drawing hole, the first ironing hole, and the second ironing hole.

5. The manufacturing apparatus for a cup-shaped member including an inner corrugated portion according to claim 4, wherein
an inner peripheral surface of the second ironing die is provided with a reduced diameter portion, an entrance tapered portion having a diameter gradually reducing from one opening edge of the second ironing hole through which the punch enters toward the reduced diameter portion, and an exit tapered portion having a diameter gradually reducing from the other opening edge on the side opposite to the one opening edge toward the reduced diameter portion.
